(19) United States
(12) Patent Application Publication
(10) Pub. No.: US 2020/0405062 A1
(43) Pub. Date: Dec. 31, 2020

(54) ULNAR NERVE ARMREST CUSHION

(71) Applicant: Javad Ghoreishi, Brookline, MA (US)

(72) Inventor: Javad Ghoreishi, Brookline, MA (US)

(21) Appl. No.: 16/914,823

(22) Filed: Jun. 29, 2020

Related U.S. Application Data
(60) Provisional application No. 62/868,981, filed on Jun. 30, 2019.

(51) Int. Cl. A47C 7/54; A47C 31/02

(52) U.S. Cl. CPC A47C 7/54; A61G 5/125; A47C 31/023

(57) ABSTRACT

An ulnar nerve armrest cushion with a cushion body, a groove centered on a top side therein, and two attachment flaps. Each attachment flap runs along the length of the cushion body on one side of the cushion. One attachment flap has a hook part of a detachable hook-and-loop fastener, and the other attachment flap has the loop part of the detachable hook-and-loop fastener so that the two attachment flaps can detachably connect underneath the cushion body to secure the cushion body to an armrest. The cushion body can be made in a variety of sizes and thicknesses to fit a variety of armrests.

### CROSS-REFERENCE TO RELATED APPLICATION

The present application is related to and claims priority from prior provisional application Ser. No. 62/868,981, filed Jun. 30, 2019 which application is incorporated herein by reference.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. Field of the Invention

The present invention relates generally to the field of ulnar nerve protection cushion devices. More specifically, the invention is an armrest pillow to relieve stress on the ulnar nerves while sitting for an extended period of time, thereby preventing damage to the ulnar nerves.

### 2. Description of the Related Art

The ulnar nerve runs from the shoulder to the littlest finger. It is not very well protected by muscle or bone at the elbow, where it runs next to the medial epicondyle, and is prone to becoming impinged or entrapped if too much pressure is put the ulnar nerve. Entrapment can cause pain in the elbow, weakness in the grip, difficulty moving the fingers, and numbness or a pins and needles sensation in the ring and littlest fingers. Severe entrapment can lead to muscle lost in the hand and/or forearm and a claw-like deformity of the ring and littlest finger.

Sitting in chairs for extended periods of time can place pressure on the ulnar nerves. Over time, this may result in a wide range of painful and distracting conditions, including numbness in the hands and fingers, mental distress, reduced sleeping, and even the inability to conduct daily activities. Some people may try to balance pillows on chair armrests, but this can be a struggle as the pillows are prone to falling off the armrests.

Another approach to protecting the ulnar nerve is wearing an elbow brace. However, elbow braces are often uncomfortable and itchy to wear for prolonged periods of time, require time and effort to take on and off, and are more expensive to manufacture than a cushion to rest the elbows on.

Various attempts have been made to solve the above-mentioned problems such as those found in U.S. Pub. Nos. 2012/0004586 to Martino. This art is representative of an elbow brace to cushion the ulnar nerve. None of the above inventions and patents, taken either singly or in combination, is seen to describe the invention as claimed.

Ideally, an ulnar nerve armrest cushion should provide a way to prevent excessive pressure from being placed on the ulnar nerve when sitting for extended periods and, yet would operate reliably and be manufactured at a modest expense. Thus, a need exists for a reliable ulnar nerve armrest cushion to avoid the above-mentioned problems.

### BRIEF SUMMARY OF THE INVENTION

In view of the foregoing disadvantages inherent in the known ulnar nerve cushion art, the present invention provides a novel armrest cushion to protect the ulnar nerve. The general purpose of the present invention, which will be described subsequently in greater detail is to provide an ulnar cushion that helps prevent damage to the ulnar nerves from prolonged sitting and minimizes numbness of the hands and tingling of the fingertips as well as pain, mental distress, and overall diminished health.

The present invention wraps around the arm of a chair for maximum convenience. The ulnar cushion saves people time and frustration having to constantly get up and move and shake their arm while allowing individuals to focus on the tasks at hand, rather than their pain.

Ulnar Cushion supports the arm when seated for extended periods of time, reducing stress on the ulnar nerves. The innovation product features a cushion-like pad that wraps an armrest and secures in place with hook-and-loop fastening material. This means of security allows users to use the pad on chairs with armrests of varying sizes with ease. The cushion has a groove in the center to hold the user's arm and/or elbow in place. Additionally, the pad can be made of memory foam with gel pouches, air bubbles, and soft flexible rubbers. The pad may also be offered in various sizes as needed. The exact specifications may vary upon manufacturing.

The present invention holds significant improvements and serves as an easily moveable and useable ulnar nerve armrest cushion. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention that are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures that accompany the written portion of this specification illustrate embodiments and method(s) of use for the present invention, an ulnar nerve armrest cushion, constructed and operative according to the teachings of the present invention.

FIG. 1 shows a perspective view illustrating an ulnar nerve armrest cushion according to an embodiment of the presently claimed invention.

FIG. 2 shows a top view illustrating an ulnar nerve armrest cushion according to an embodiment of the presently claimed invention.

FIG. 3 shows a bottom view illustrating an ulnar nerve armrest cushion according to an embodiment of the presently claimed invention.

FIG. 4 shows a perspective view of an ulnar nerve armrest cushion secured around an armrest according to an embodiment of the presently claimed invention.

FIGS. 5A-5B respectively show a perspective view and an up-close view of an ulnar nerve armrest cushion built into an armrest according to an embodiment of the presently claimed invention.

The various embodiments of the present invention will hereinafter be described in conjunction with the appended drawings, wherein like designations denote like elements.

### DETAILED DESCRIPTION

As discussed above, embodiments of the present invention relate to an ulnar nerve cushion and more particularly to an ulnar nerve armrest cushion as used to prevent excessive pressure being placed on the ulnar nerve while sitting for extended periods of time.

Generally speaking, an ulnar nerve armrest cushion is a cushion-like pad that wraps an armrest and secures in place with hook-and-loop fastening material. This means of security allows users to use the pad on chairs with armrests of varying sizes with ease. The cushion has a groove in the center to hold the user's arm and/or elbow in place. Additionally, the pad can be made of memory foam and soft flexible rubber materials, and can have gel pouches and air bubbles to provide additional cushioning.

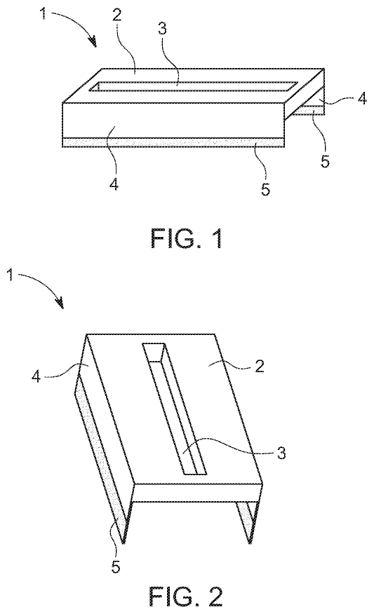

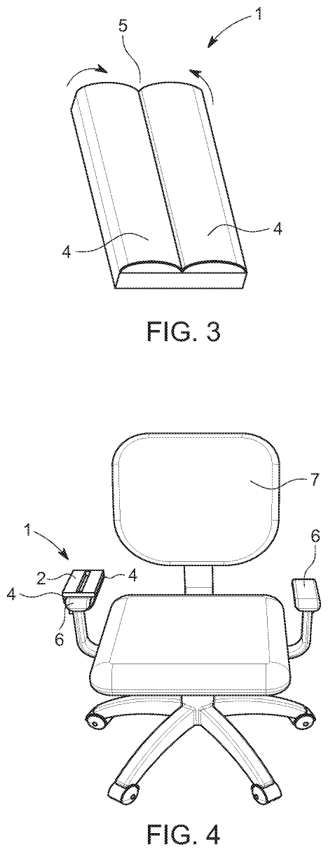

Referring to the drawings by numerals of reference there is shown in FIGS. 1-3, the ulnar nerve armrest cushion 1 includes a cushion body 2 with a groove 3 centered therein. The cushion body 2 can be manufactured at any desirable size for an armrest cushion, but is preferably 32 cm long, 17 cm wide, and 3 cm thick. The groove 3 is a cut out that goes partially through the thickness of the cushion body 2. Along the length of the cushion body 2 on each side is an attachment flap 4. Each of the two attachment flaps 4 have a strip of a hook-and-loop material 5, such as Velcro, at the bottom end. Each flap 4 is manufactured to have the same length as the cushion body 2, and is preferably 10 cm wide, so that 3 cm of the flaps 4 cover the sides of the cushion body 2 and the remaining 7 cm of the flaps 4 can wrap around an armrest 6 and attach to each other to hold the cushion body 2 in place. The flaps 4 can be any width needed to secure the cushion body 2 to the armrest 6.

Referring now to FIG. 4, showing the ulnar nerve armrest cushion 1 attached to an armrest 6 of a chair 7. The two attachment flaps 4 wrap around the armrest 6, securing the cushion body 2 to the armrest 6 so a user can lean on the ulnar nerve armrest cushion 1 without the cushion body 2 falling off the armrest 6. The cushion body 2 pads the user's elbow and ulnar nerve, preventing unnecessary pressure on the ulnar nerve.

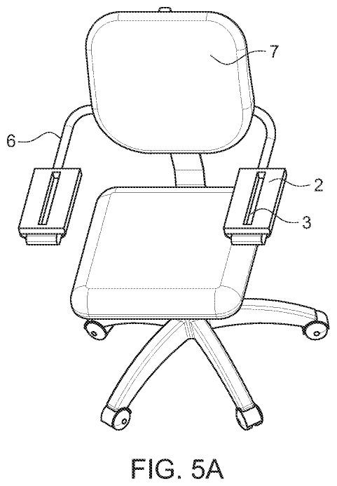

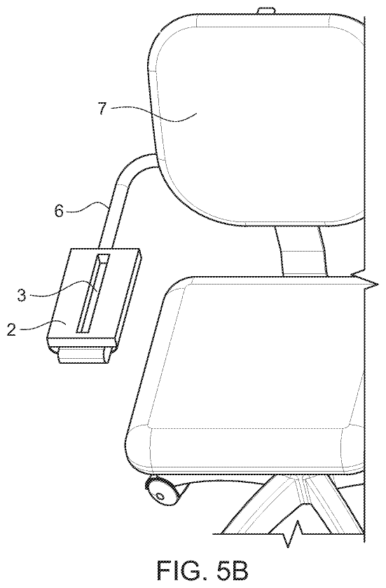

Referring now to FIGS. 5A-5B, the ulnar nerve armrest cushion 1 can alternately be formed as the armrest 6, so that the cushion body 2 forms the main part of the armrest 6, with the groove 3 centered therein. The armrest can be part of a chair, or sold individually as a replacement armrest.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. An ulnar nerve armrest cushion comprising:
(a) a cushion body with a length, width, and thickness;
(b) a groove operably arranged within a top side of the cushion body to support a user's forearm or elbow or forearm and elbow;
(c) a first attachment flap operably connected along the length of a left side of the cushion body;
(d) a second attachment flap operably connected along the length of a right side of the cushion body; and
(e) a detachable hook-and-loop fastener with a hook part and a loop part,
wherein the hook part is operably connected along a bottom length of either the first attachment flap or the second attachment flap, and wherein loop part is operably connected along a bottom length of the other of the first attachment flap or the second attachment flap so that the first attachment flap and the second attachment flap are connectable along an underside of the cushion body.

2. The ulnar nerve armrest cushion according to claim 1, wherein the cushion body comprises a material selected from the group consisting of memory foam and soft flexible rubber materials.

3. The ulnar nerve armrest cushion according to claim 1, wherein the cushion body includes gel pouches, or air bubbles, or gel pouches and air bubbles, operably arranged around the groove to provide additional cushioning to the user's forearm, or elbow, or forearm and elbow.

4. The ulnar nerve armrest cushion according to claim 1, wherein the length of the cushion body is 32 cm, the width of the cushion body is 17 cm, and the thickness of the cushion body is 3 cm,
wherein the first attachment flap has a length of 32 cm and a width of 10 cm, and
wherein the second attachment flap has a length of 32 cm and a width of 10 cm.

5. An ulnar nerve armrest cushion comprising:
(a) a cushion body with a length of 32 cm, a width of 17 cm, and a thickness of 3 cm,
wherein the cushion body is formed from a material selected from the group consisting of memory foam and soft flexible rubber materials;
(b) a groove operably arranged within a top side of the cushion body to support a user's forearm or elbow or forearm and elbow,
wherein the cushion body includes gel pouches, or air bubbles, or gel pouches and air bubbles, operably arranged around the groove to provide additional cushioning to the user's forearm, or elbow, or forearm and elbow;
(c) a first attachment flap operably connected along the length of a left side of the cushion body with a length of 32 cm and a width of 10 cm;
(d) a second attachment flap operably connected along the length of a right side of the cushion body with a length of 32 cm and a width of 10 cm; and
(e) a detachable hook-and-loop fastener with a hook part and a loop part,
wherein the hook part is operably connected along a bottom length of either the first attachment flap or the second attachment flap, and
wherein loop part is operably connected along a bottom length of the other of the first attachment flap or the second attachment flap so that the first attachment flap and the second attachment flap are connectable along an underside of the cushion body.

6. An ulnar nerve armrest cushion comprising:
(a) an armrest with a length, width, and thickness,
wherein the armrest is formed of a cushion material;
(b) a groove operably arranged within a top side of the armrest to support a user's forearm or elbow or forearm and elbow,
wherein a base and sides of the groove are formed of the cushion material.

7. The ulnar nerve armrest cushion according to claim 6, wherein the ulnar nerve armrest cushion is operably connected to a chair to serve as an armrest.
